(19) United States
(12) Patent Application Publication
(10) Pub. No.: US 2002/0078085 A1
(43) Pub. Date: Jun. 20, 2002

(54) Terminal device, information collecting system, and information collecting method

(75) Inventor: Tsuneyuki Kikuchi, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/023,026

(22) Filed: Dec. 17, 2001

(30) Foreign Application Priority Data
Dec. 18, 2000 (JP) 383652/2000

(51) Int. Cl. G06F 17/00

(52) U.S. Cl. 707/501.1

(57) ABSTRACT

An information collecting system including a portable information terminal 10, an Internet service provider 30, and a portable telephone network 20 to connected the terminal 10 and the provider 30 to each other collects information of taste of a user who browses a content provided by a web server 41 or 42 connected to an Internet network 40. The terminal includes a content requesting unit, a counting unit for counting a number of requests of a content, and a notifying unit for notifying information of a content of which the number of requests satisfies a predetermined notification condition, the information being added to a content request. The provider 30 includes a taste information server 32 for receiving the content request, counting the number of notifications of the added information, removing the added data, and transferring the content request to the is web server 41 or 42 as a request destination and a personal information storage memory 37 to store the number of notifications and the user information with a correspondence established therebetween. This lowers the load on the service provider to install facilities to collect personal information such as the taste information.

### BACKGROUND OF THE INVENTION

The present invention relates to a terminal device, an information collecting system, and an information collecting method for collecting information of taste of a user who browses contents supplied by a content server connected to an Internet network.

### DESCRIPTION OF THE PRIOR ART

In a known information providing service using a terminal device such as a personal computer connected to a fixed telephone line and a portable telephone capable of communicating data connected to an Internet network, the information providing service selectively provides, a user who uses services such as the browsing of news items, information retrieval, and e-mail reception provided by various servers connected to the Internet network, with information and advertisement in fields matching taste of the user. Such an information providing service includes an information collecting system for the service provider to acquire information of taste of the user.

FIG. 19 shows a configuration of an example of the information collecting system in which a portable telephone is used as a terminal device. The configuration of FIG. 19 includes a portable telephone 310 connected via wireless communication to a base station 321. The base station 321 is coupled with a portable telephone network 320 connected to an Internet network 340. The Internet network 340 is linked to a content server 342 to provide various contents. Between the portable telephone network 320 and the Internet network 340, an Internet service provider 330 is arranged to serve as a gateway of communication protocols and to reserve a link to the content server 342. The portable telephone 310 therefore can access a desired content server 342 via the Internet service provider 330.

The Internet service provider 330 includes, in addition to an Internet connecting device coupled to the portable telephone 310 with the Internet network 340, a subscriber information database 331, a position and account information database 332, a taste information database 333, and an information collecting server 334. The subscriber information database 331 stores therein, for example, subscriber information of a subscriber such as an address, an age, and his or her gender obtained when the subscriber enters a contract for the service. The position and account information database 332 is disposed to store information items of, for example, positional information and account information of the portable telephone 310. The taste information database 333 stores taste information of taste of a user such as a hobby, an interested field, and purchasing desire.

The information collecting server 334 accesses, on receiving a message from a user, a portable telephone 310 and establishes a link thereto to distribute a guide message and questionnaire data in voice thereto to ask for cooperation. On receiving data for the questionnaire, the information collecting server 334 converts the data into a predetermined format to store the converted data in the taste information database 333. The server 334 repeatedly reads the data from the database 333 at a predetermined interval of time to make summation of the data and analyzes the resultant data by also referring to the data in the subscriber information database 331 and the position and account information database 332 to supply a result of the analysis to a third party.

The information collecting system of this kind is attended with a problem as below. When many accesses are issued from users of the system in a concentrated fashion in the information collecting system, the amount of data distributed from the information collecting server to each terminal device becomes quite small, and hence the number of users who cannot establish connection to the system increases. To solve the problem in the prior art, a plurality of information collecting servers and a plurality of databases are arranged to distribute the load of the system. However, this increases the cost of the system facility of the service provider.

Moreover, assume an operation in which the results of the questionnaire thus collected is immediately totaled to be analyzed so as to extract information of taste of the users and the information is reflected in the information supply for an advertisement or the like within the access time. In this case, the information collecting server must have higher processing performance. In the prior art, to prevent the increase in the cost of the system facility, the information of taste collected in an access is only reflected in the information supply at an access subsequent to the access. This leads to a problem that the information supply operation cannot satisfy the user's request in the information collection.

### SUMMARY OF THE INVENTION

It is therefore an object of the present invention to provide a terminal device, an information collecting system, and an information collecting method in which the cost of the system facility of the service provider to collect information of taste of a user and the like can be reduced.

To solve the problem in accordance with the present invention, there is provided a terminal device coupled via a communication line to Internet connection service providing means for browsing via an Internet network a content server having stored contents therein. The terminal device includes content requesting means for issuing a content request to request a content selected by a user according to a content menu disposed for the user to select a desired content, counting means for counting a number of requests of a content requested by said content requesting means, and notifying means for notifying information of a content of which the number of requests satisfies a predetermined notification condition, the information being added to the content request.

In this case, the counting means comprises, for example, storage means for storing therein the number of requests for each address of a content server in which the content selected by the user is stored and adding means for adding the number of requests of the content for each request for the content. Additionally, another configuration example of the counting means comprises storage means for storing therein an address of said content server in which the content selected by the user is stored and a day and time of the selection, and totaling means for conducting a retrieval through said storage means and for totaling the number of requests for each content within a predetermined period of time.

In this configuration, by using a uniform resource locator (URL) to indicate an address of a content server to supply a content as information of a content to be added to a content request and an identifier indicating a satisfying state of a notification condition, the terminal device in accordance with the present invention has a function to notify that the content belongs to a field matching taste of the user.

Furthermore, the terminal device includes wireless communication means to be coupled with said communication line via wireless communication. In this case, the configuration example corresponds to a portable telephone and a portable information terminal (a personal digital assistant). The content request means of the terminal device may include a unit for receiving and storing the content menu therein. In this case, the content request means may be connected to a server to supply a content menu to rewrite or to update the content menu. The notification means of the terminal device may include means for receiving a notification condition and for storing the notification condition. As a result, the processing condition of information to be collected can be changed if necessary. In this case, the notification condition are indicated by, for example, the counting period of the number of requests for the notification means to make a decision, each setting value of the count number, and a limitation flag to restrict notification in one field within the counting period. Furthermore, the notification means adds, to the content request, information of contents set as a notification object by the re-setting of the notification condition.

As above, the terminal device in accordance with the present invention includes the means to count the number of requests of browsing which user issued to the content server and the means to notify the information when the number of requests satisfies a predetermined notification condition. Therefore, the terminal device collects, in place of the information collecting server of the prior art, information of taste of the user. The taste of the user is consequently determined by each terminal device, and hence the load imposed on the information collecting server is lowered.

Furthermore, in accordance with the present invention, there is provided an information collecting system for collecting taste information of taste of a user who browses a content provided by a content server connected to an Internet network, comprising the terminal device described above, Internet connection service providing means, and a communication network for mutually connecting a plural units of said terminal devices and said Internet connection service providing means to each other. The Internet connection service providing means' comprises counting means for receiving a content request sent from the terminal device and counting a number of notifications of information of a content added to the content request, storage means for storing the number of notifications and user information of the user with a correspondence established therebetween, and transfer means for removing data added to the content request and for transferring the content request to a content server as a request destination.

A configuration example of the information collecting system comprises a terminal device including means for receiving a content menu and for storing the content menu and content menu providing means connected via an Internet network to the Internet connection service providing means for the user to select a desired content. Another configuration example of the information collecting system comprises a terminal device including means for receiving a notification condition and for storing the notification condition and Internet connection service providing means including notification condition transmitting means for transmitting a notification condition to the terminal device.

Moreover, the information collecting method in accordance with the present invention is an information collecting method of collecting taste information of taste of a user who browses a content provided by a content server connected to an Internet network, comprising the steps of counting, by a terminal device, a number of requests for each content to which the terminal device issued a request; adding, to a content request, information of the content of which the number of requests satisfies a predetermined notification condition and thereby notifying the information of the content and receiving, by an Internet connection service providing means, a content request sent from the terminal device, counting a number of notifications of information of a content added to the content request, storing the number of notifications and user information of the user with a correspondence established therebetween, and removing data added to the content request and transferring the content request to a content server as a request destination.

A configuration example of the information collecting method includes the steps of transmitting, by content menu providing means including a content menu for the user to select a desired content, the content menu via the Internet connection service providing means to the terminal device and receiving the content menu by the terminal device for use of selection of a content and request for a content. Moreover, another configuration example of the information collecting system includes the steps of transmitting the notification condition by Internet connection service providing means and receiving, by the terminal device, the notification condition, adding information of the content to a content request, and notifying the content request.

### BRIEF DESCRIPTION OF THE DRAWINGS

The objects and features of the present invention will become more apparent from the consideration of the following detailed description taken in conjunction with the accompanying drawings in which:

FIG. 1 is a schematic block diagram showing a configuration of a first embodiment of an information collecting system in accordance with the present invention;

FIG. 2 is a block diagram showing a primary section of a hardware configuration of a portable information terminal or a personal digital assistant of FIG. 1;

FIG. 3 is a schematic diagram for explaining a keyword registering operation for a keyword transmission server;

FIG. 4 is a table for explaining an example of the contents of keyword storage memory A;

FIG. 5 is a flowchart showing processing of a taste information server when a portable information terminal issues a request for an Internet connection;

FIG. 6 is a table for explaining an example of the contents of an authentication information memory;

FIG. 7 is a list for explaining an example of a description format of contents including a service menu;

FIG. 8 is an explanatory diagram showing an example of a service menu displayed on a portable information terminal;

FIG. 9 is a diagram for explaining an example of a description format of a content request transmitted from a portable information terminal;

FIG. 10 is a flowchart showing processing executed when a user selects a menu of a portable information terminal;

FIG. 11 is a table for explaining an example of contents of a taste storage memory of a portable information terminal;

FIG. 12 a flowchart showing processing of a taste information server when a portable information terminal issues a content request;

FIG. 13 is a schematic diagram for explaining an example of contents of a personal information storage memory;

FIG. 14 is a diagram for explaining operation from when a web server receives an access to when an information providing server supplies an advertisement;

FIG. 15 is a diagram for explaining an example of a description format of a static parameter setting request;

FIG. 16 is a flowchart for explaining processing when a user selects a menu of a portable information terminal in a second embodiment in accordance with the present invention;

FIG. 17 is a diagram for explaining an example of a description format of a content request transmitted from the portable information terminal in the second embodiment;

FIG. 18 is a flowchart for explaining processing of a taste information server when the portable information terminal issues a content request in the second embodiment; and

FIG. 19 is a schematic diagram of an information collecting system of the prior art.

### DESCRIPTION OF THE EMBODIMENTS

Referring next the drawings, description will be given of an embodiment of the present invention.

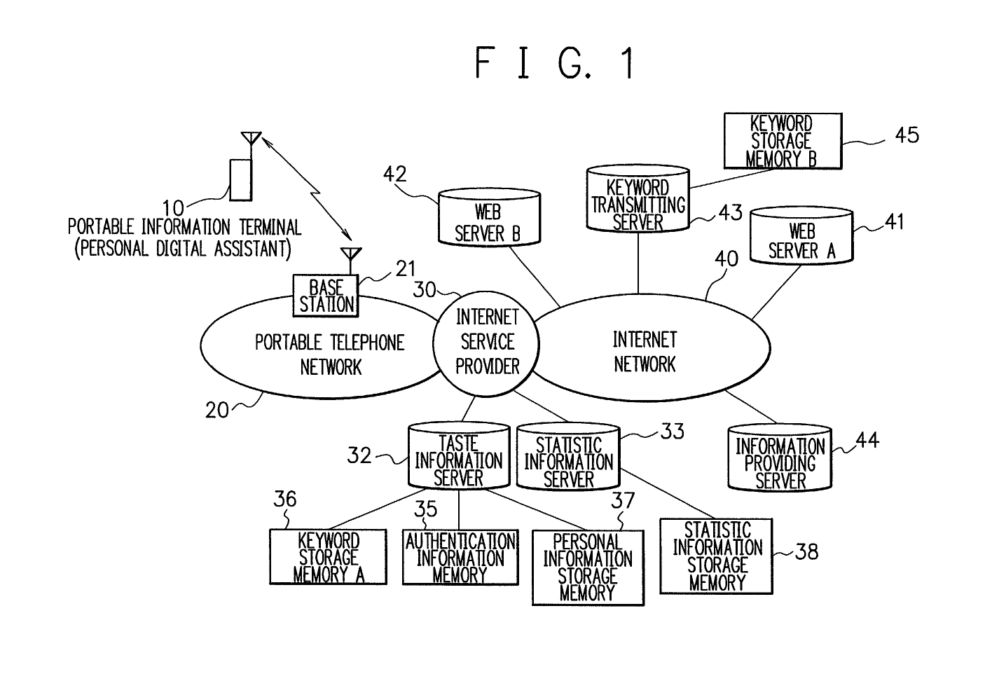

FIG. 1 shows, in a schematic diagram, a configuration of a first embodiment of an information collecting system in accordance with the present invention. In the configuration, a portable information terminal 10 such as a portable computer having a wireless communication function or a portable telephone is connected via wireless communication to a wireless base station 21 coupled with a portable telephone network 20. The network 20 is linked to an Internet network 40 via an Internet connection unit, not shown, of an Internet service provider 30 such as a communication enterprise or an Internet connection service enterprise. The portable telephone network 20 may be directly coupled with the Internet connection unit or may be coupled therewith via a communication network such as a subscriber telephone network or a leased line.

The Internet service provider 30 includes an Internet connection unit, not shown, including a gateway server to communicate data with the portable information terminal, a router to establish connection to the Internet network 40, a server to conduct various services, and a network to connected these constituent components to each other; a taste information server 32, and a static information server 33. The Internet connection unit is constructed in a known configuration and hence description thereof will be avoided. The taste information server 32 has functions, for example, to authenticate a user, to process a service request received from a portable information terminal 10, and to store taste information. The server 32 includes an authentication information memory 35 to store user identifier numbers and passwords with a one-to-one correspondence established therebetween, a keyword storage memory A 35 to store requesters of contents and keywords with a one-to-one correspondence therebetween, and a personal information storage memory 37 to store user identifier numbers and keywords with a one-to-one correspondence established therebetween. The static information server 33 totals and analyzes the contents of the personal information memory 37 and includes a static information storage memory 38 to store the data totaled and analyzed as above.

The Internet network 40 is coupled with a web servers A 41 and B 42, a keyword transmitting server 43, and information providing server 44. The web servers A 41 and B 42 are content servers to provide various contents through a worldwide web (WWW) and store therein as portal sites various contents such as service menus, news items, and shopping articles. The keyword transmitting server 43 has a function to send keywords indicating interesting fields of users to these servers and includes a keyword storage memory B 45 to store keyword providing pairs of destinations and keywords, and keywords and addresses of information providing servers 44 with a one-to-one correspondence respectively, established therebetween. The information providing server 44 stores therein information such as an advertisement of goods and a guidance to a seminar to be provided to users.

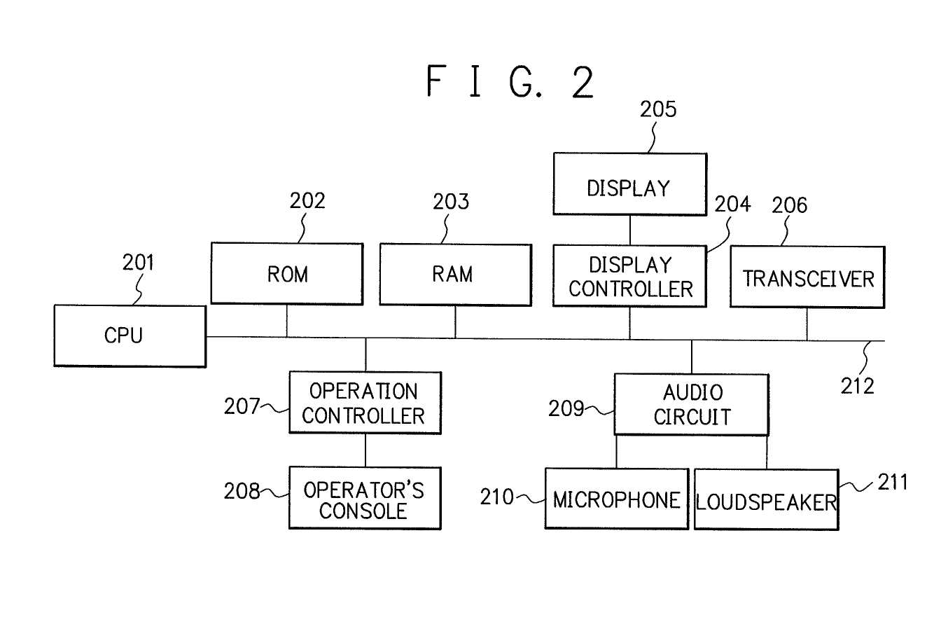

FIG. 2 shows a main section of a hardware configuration of the portable information terminal 10 of FIG. 1 in a block diagram. The terminal 10 includes a central processing unit (CPU) 201, a read only memory (ROM) 202, a random access memory (RAM) 203, a display control circuit 204, a display 205, a transmitting and receiving circuit 206, an operation control circuit 207, an operator's console section 208, an audio circuit 209, a microphone 210, a loudspeaker 211, and a bus 212. The CPU 201 is linked via the bus 212 to the respective constituent sections of the system. The ROM 202 stores programs and fixed data items for various control operations of the portable information terminal 10. The RAM 203 is a working memory and includes a storage which can be installed in and removed from a main section thereof. The display controller 204 is a circuit to visually display data on the display 205 such as a liquid-crystal display integrally arranged in the portable information terminal 10.

The transceiver circuit 206 is a circuit to communicate data via an antenna. The operation controller 207 is disposed to input operation data from the operator's console 208 such as a button-switch unit and a keyboard. The audio circuit 209 controls input and output operations of voices and tones and is connected to the microphone 210 and the speaker 211. The web servers A 41 and B 42 and the information providing server 44 are basically equal in structure to an ordinary computer and hence description thereof will be avoided. The taste information server 32, the statistic information server 33, and the keyword transmitting server 43 are also the same in constitution as the servers A 41, B 42, and 44. However, as distinct therefrom, the servers 32, 33, and 43 include various memories.

Next, description will be given of operation of the information collecting system according to an example of a sales activity for a new set of golf clubs in which an advertisement is supplied only to users interested in the field of this sport. In this situation, the web server A 41 stores a service menu as contents of a portal site. When a content request is received from a requester, the web server A 41 sends data of the service menu to the requester. The web server B 42 stores information “A Way To Golf Score 100” as its contents. The information providing server 44 stores therein an advertisement of the new set of golf clubs.

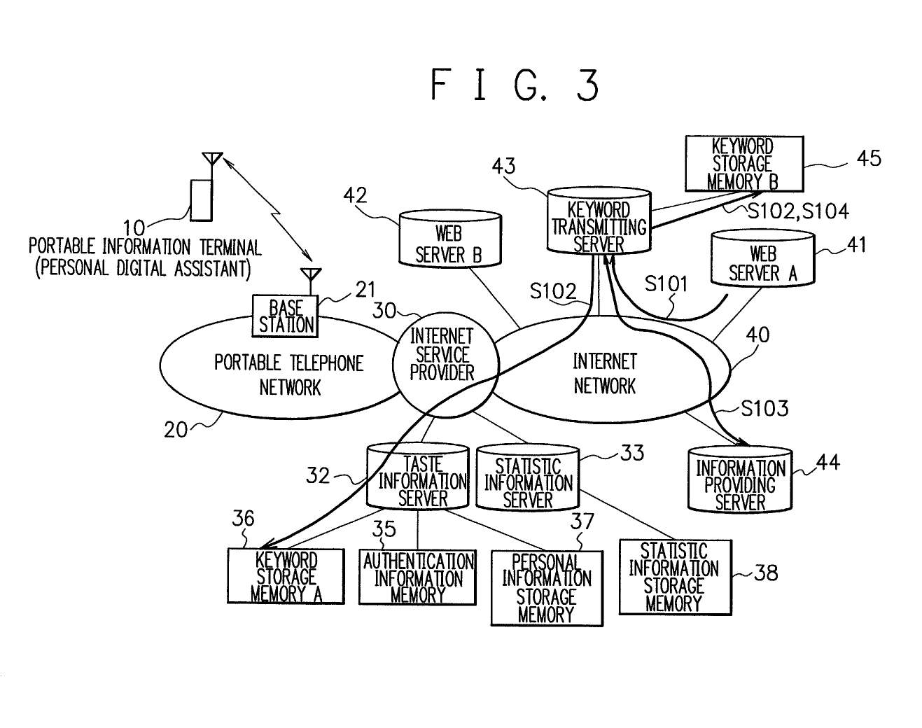

FIG. 3 shows, in an explanatory diagram, operation of the information providing server 44 of an advertiser or an advertisement agent up to a point in which the server 44 registers a keyword for the keyword transmitting server 43. As shown in FIG. 3, the keyword transmitting server 43 beforehand receives a service menu from the web server A 41 to provide a service menu. The server 43 extracts, from each menu of the received service menu, a keyword of an interesting field of a user as well as a content storage location to which a link is established when the user selects the menu. The server 43 then generates a table in which the keywords and the content storage locations are stored with a one-to-one correspondence established therebetween (step S101). The server 43 stores the table in the keyword memories A 35 and B 45 (step S102). Each menu of the service menu can be used as a keyword to indicate an interesting field of a user.

Subsequently, the information providing server 44 acquires a list of keywords from the keyword transmitting server 43 to detect a keyword “golf” and then transmits the keyword “golf” and an address thereof on the Internet to the keyword transmitting server 43 (step S103). The server 43 stores an address of the information providing server 44 for a set of the keyword “golf” and a content storage location of the keyword memory B45 (step S104). Resultantly, at timing when a user accesses a content item regarding “golf”, the information providing server 44 can receive a notification from the keyword transmitting server 43.

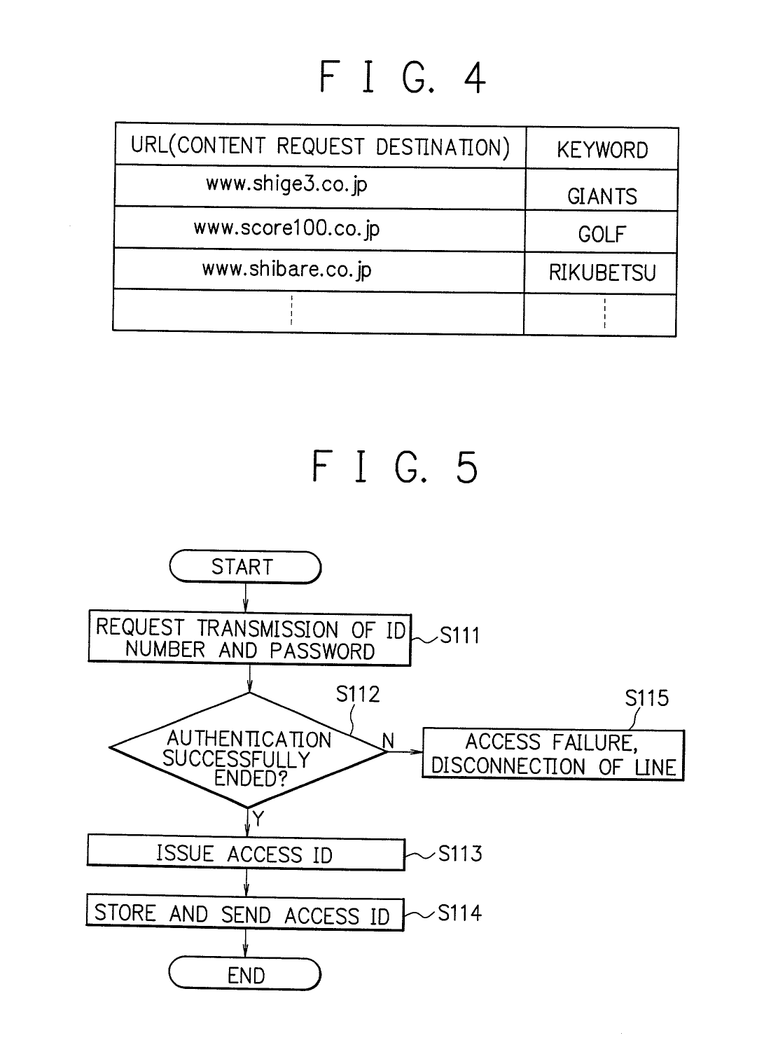

FIG. 4 shows an example of data stored in the keyword memory A 36 in a table. In the memory A 36, URL (uniform resource locators) of content request destinations and keywords indicating interesting fields of users are stored with a one-to-one correspondence established therebetween. The keyword memory B 45 stores, in addition to the sets of URL and keywords described in conjunction with the keyword memory A 36, an address of an information providing server 44 which requests a notification from the keyword transmitting server 43 when a user interested in the keyword accesses the keyword memory B 45.

Description will be given of operation in this situation in which an Internet connection request is issued to the Internet service provider 30. FIG. 5 shows in a flowchart an operation of the taste information server 32 when the portable information terminal 10 establishes a connection via a communication line to the Internet service provider 30 and issues an Internet connection request to the provider 30. When a wireless line is connected between the terminal 10 and the taste information server 32, the server 32 requests the terminal 10 to send a user identifier number and a password (step S111). Then having received a user identifier number and a password therefrom, the server 32 notifies to the user at service contract to conduct authentication by comparing the set of a user identifier number and a password with a set of a user identifier number and a password stored in the authentication information memory 35.

In the comparison, when the sets match each other (Y in step S112), the taste information server 32 issues an access identifier (ID) which is necessary for the access and which includes a character string uniquely defined in the overall system (step S113). The server 32 then stores the access ID in the authentication information memory 35 and sends the access ID to the portable information terminal 10 to be stored therein (step S114). On the other hand, the sets does not match each other (N in step S112), the server 32 assumes that the authentication fails and hence disconnects the line (step S115).

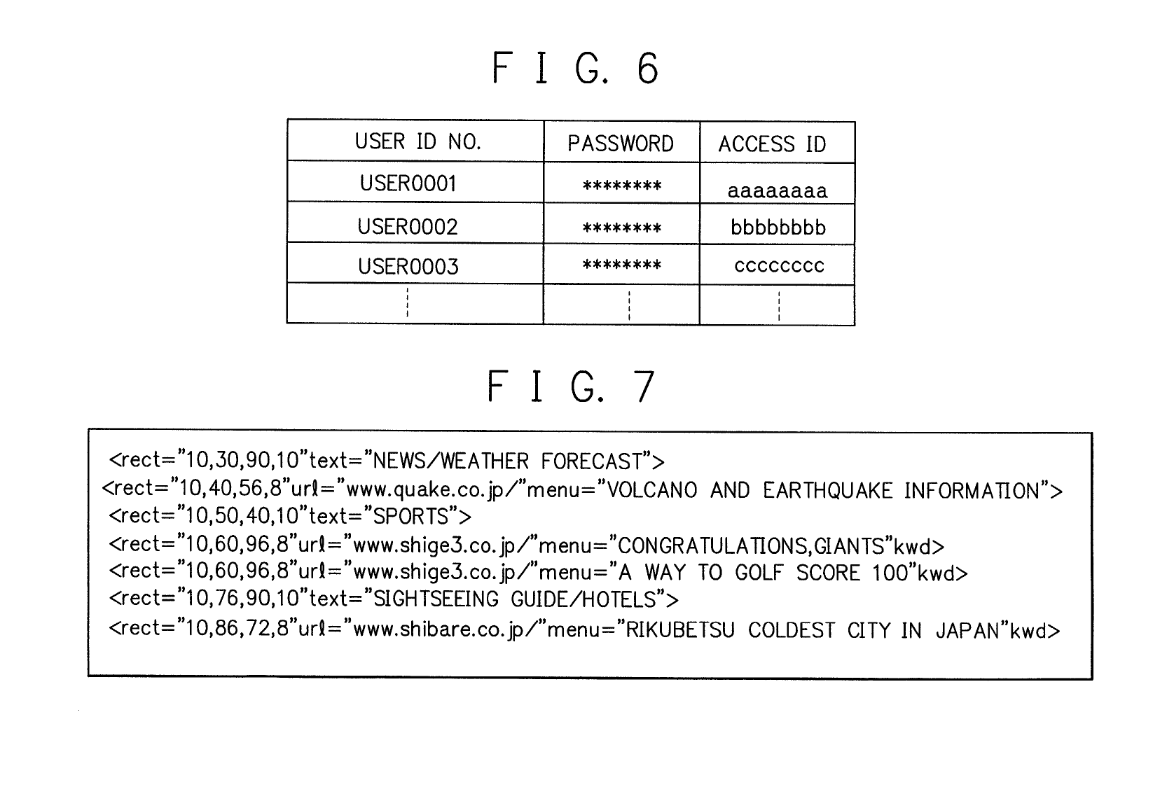

Thereafter, by transmitting the access ID and a content request, the portable information terminal 10 can bypass the authentication using the user ID number and the password. That is, the terminal 10 can directly access the web server 41 via the taste information server 32. FIG. 6 shows an example of data of the authentication information memory 35 in a table. In the memory 35, an identification number and a password of a user notified to the user at service contract are stored with a one-to-one correspondence established therebetween. After the authentication is successfully finished at line connection and an access ID is issued, the authentication information memory 35 stores the access ID until the access ID becomes invalid. The access ID is controlled by a timer. When no access is received for a predetermined period of time from the portable information terminal 10, the access ID is regarded as invalid and is cleared in the authentication information memory 35. As a result, an event in which the ID number and the password of the user are sent to the network is prevented, and the authentication can be achieved at a high speed.

In this case, when the portable information terminal 10 issues a content request via the Internet service provider 30 to the web server A 41, the web server A 41 sends data of a service menu of FIG. 7 to the terminal 10. FIG. 7 shows an example of a description format of contents including a service menu. In this example, an identifier “menu” indicates that a content described between quotation marks (“) is a service menu. An identifier “text” designates that a content between quotation marks is text information. An identifier “rect” indicates that numeric values sandwiched between quotation marks are a start point (a pair of coordinates x and y), width, and height of an area in which the contents are to be displayed. An identifier “url” designates that a content between quotation marks is an address (URL) of a web server to which a new content is distributed when a user selects the menu. An identifier “kwd” indicates that the contents of the menu includes a keyword designating an interesting field of the user. An identifier < >designates that the contents enclosed between < and > are mutually related to each other.

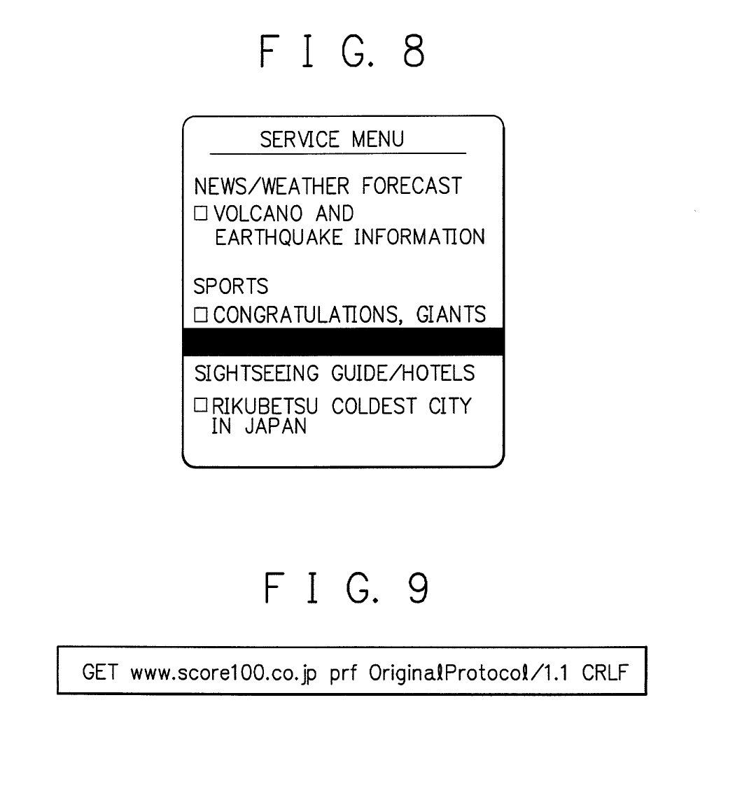

Having received the data of a service menu shown in FIG. 7, the portable information terminal 10 stores the data in the RAM 203. The CPU 201 executes a program stored in the ROM 202 to conduct processing to display a service menu of FIG. 8 on the display 205. FIG. 8 shows an example of a service menu displayed on the display 205 when the terminal 10 accesses the web server A 41. This example includes service menu items “Volcano and earthquake information”, “Congratulations, Giants”, “A way to golf score 100”, and “Rikubetsu, Coldest city in Japan”. It is not limited that the service menu is provided only from a web server. For example, a mail server, not shown, connected to the Internet may provide the data of the service menu shown in FIG. 7 by e-mail, or a server of the Internet service provider 30 may provide the data. Alternatively, the data may be stored on an installable and detachable storage medium of the RAM 203 for this purpose.

Next, when a user interested in the field of golf operates, for example, a button-switch unit to select “A way to golf score 100”. In response thereto, the CPU 201 generates a content request shown in FIG. 9 and issues the content request via the Internet service provider 30 to the web server B 42. FIG. 9 shows an example of a description format of a content request sent from the terminal 10. In the example, the content request begins with an identifier “GET” indicating that this is a content request. After the identifier “GET”, an address of a web server to which a new content is to be distributed follows. If the content to be requested is an interesting field, an identifier “prf” is then described. Thereafter, a type and a version number of communication protocol and an end code follow. The respective elements are separated by a space from each other. In the description format, the identifier “kwd” or “prf” is minimum information necessary to indicate that the content includes a keyword denoting an interesting field or that the content is an interesting field. That is, these identifiers are not limited to the character strings “kwd” and “prf”.

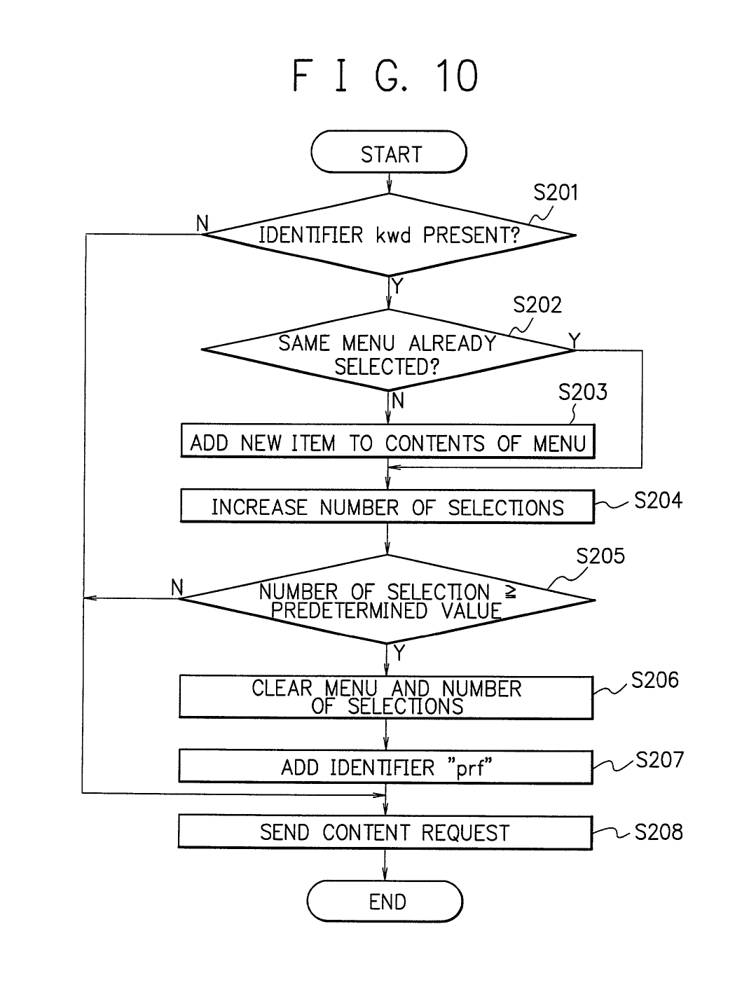

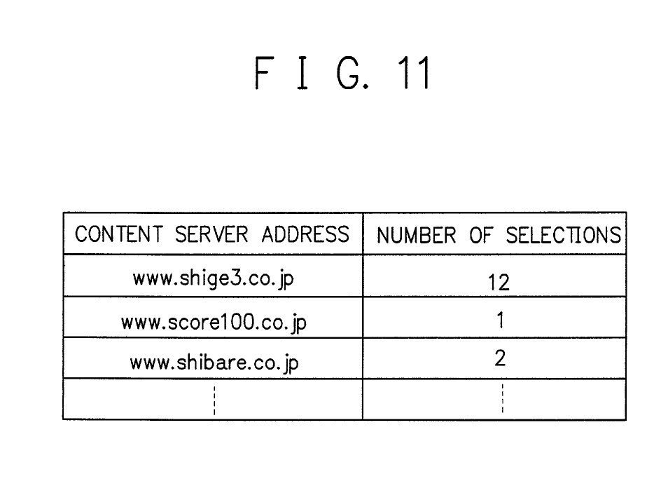

Referring now to FIG. 10, description will be given of operation when the user selects a menu of the terminal 10. FIG. 10 shows the operation in a flowchart. If the selected menu includes an identifier “kwd”, the terminal 10 makes a check, by conducting a retrieval through an interesting field storage memory, to determine whether or not the same menu has been selected (step S202). In the interesting field storage memory, the contents of service memories selected in the past and the numbers of selections are stored with a one-to-one correspondence established therebetween. That is, as shown in FIG. 11, the data includes entries each of which includes an address of a web server corresponding to a menu selected in the past and the number of selections. In this case, the interesting field storage memory is arranged in the RAM 203. The CPU 201 therefore makes a search through the RAM 203 whether or not an address of a web server corresponding to the selected menu exists in the data.

If the menu has already been selected before (Y in step S202), the number of selections of the address equal to the web server address corresponding to the selected menu is incrementally increased (step S204). If the menu has not been yet selected before (N in step S202), the address of the web server corresponding to the selected menu is added to the interesting field storage memory (step S203) and number of selections of the address is incrementally increased (step S204). In this connection, when an address of a web server is first added to the interesting field storage memory, the initial value of the number is “0” . This value is set to “1” in step 204.

Subsequently, whether or not the number of selections is equal to or more than a predetermined value (step S205). If the number is equal to or more than a predetermined value (Y in step S205), the address of the web server corresponding to the menu and the number of selections are cleared in the interesting field storage memory (step S206). An identifier “prf” is then added after the URL in the content request (step S207) and then the content request is transmitted (step S208). If the selected menu does not includes an identifier “kwd” (N in step S201) or if the number of selections is less than a predetermined value (N in step S205), the content request is transmitted without an identifier “prf”.

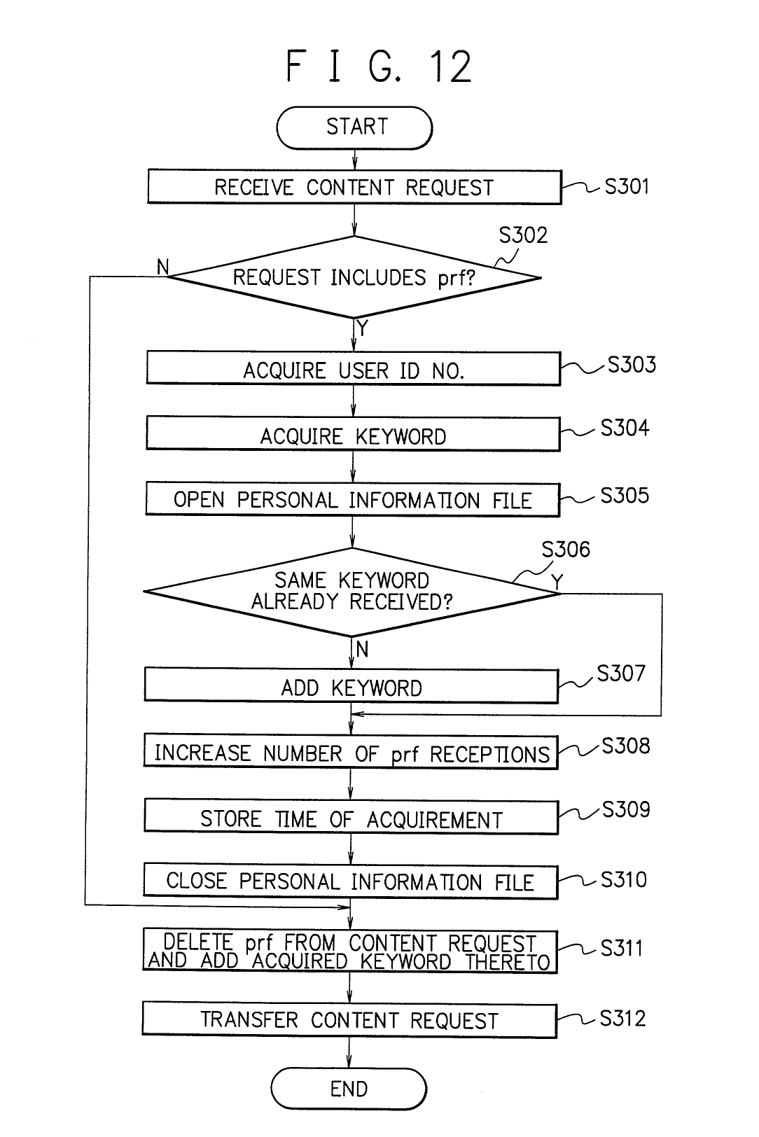

The content request sent from the terminal 10 according to the service menu is received by the Internet service provider 30 and is processed by the taste information server 32. Referring now to FIG. 12, operation of the server will be described. FIG. 12 shows a flow of processing of the server 32 when the terminal 10 issues a content request using the service menu. The taste information server 32 receives a content request from the terminal 10 (step S301). If an identifier “prf” follows the URL in the content request (Y in step S302), the server 32 acquires a user identifier number from the authentication information memory 35 according to an access ID included in the content request (step S303) and then acquires, also according to the URL (content request destination) in the content request, a keyword indicating an interesting field of the user from the keyword storage memory A 36 (step S304).

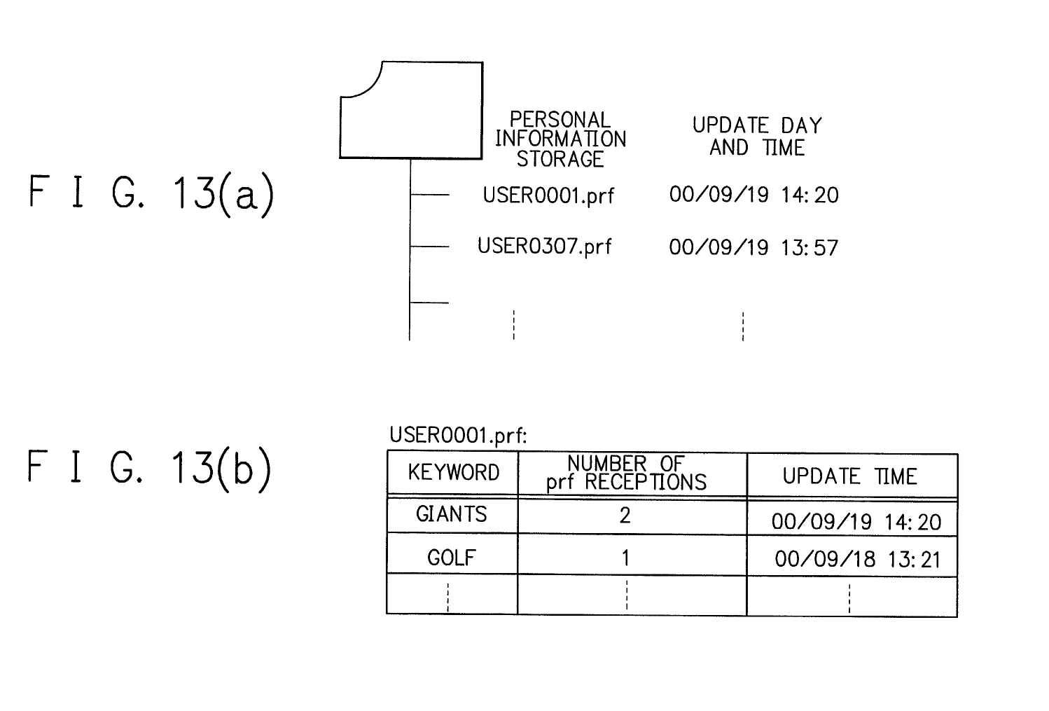

Next, the server 32 opens, according to the acquired user identification number, an information file corresponding to the user according to the personal information storage memory 37 (step S305) and determines whether or not the keyword has been stored in the file (step S306). The personal information storage memory 37 will now be described. FIG. 13 shows an example of data stored in the personal information storage memory 37 including a file layout (a) and file contents (b). In the memory 37, a file is arranged for each user. Information of a day and a point of time at which the file is updated can be obtained from attribute information of the file. In the file, a keyword indicating an interesting field of the user, the number of receptions of the identifier “prf”, and a time at which the number is updated are stored with a one-to-one correspondence established therebetween.

As a result of the check, if the same keyword has already been stored (Y in step S306), the number of receptions of the identifier “prf” associated with the keyword is incrementally increased (step S308). Otherwise, (N in step S306), the keyword is added to the file (step S307) and the number of receptions of the identifier “prf” associated with the keyword is incrementally increased (step S308). Incidentally, when a keyword is first added to the file, the initial value of the number of receptions of the identifier “prf” is “0”. This value is set to “1” in step S308.

After the number of receptions of the identifier “prf” is thus increased in step S308, a current time of the operation is stored (step S309) and the file is closed (step s310). It is assumed in this case that a time at which the file is closed is written in the attribute field of the file. The time information is used when the statistic information server 33 totals the contents of the personal information storage memory 37 to generate a taste information database to be supplied to a third person. Subsequently, the identifier “prf” is removed from the content request, and a keyword indicating an interesting field of the user obtained from the keyword storage memory A 36 is added in place of the identifier (step S311). The content request is then transferred to a web server as the content request destination (step S312). In step S302, if the identifier “prf” is absent after the URL in the content request, the content request is directly transferred to a web server as the content request destination (step S312).

Referring next to FIG. 14, description will be given of operation after a web server receives the content request. FIG. 14 shows an operation from when the web server receives a content access to when the information providing server receives a notification to provide an advertisement. First, the web server B 42 receives a content request transferred from the taste information server 32 (step S401). The web server B 42 analyzes the content request. If the content request includes a keyword, the web server B 42 notifies the reception of the content request including a keyword to the keyword transmitting server 43, and then waits for a response from the server 43 (step S402).

The keyword transmitting server 43 makes a search through the keyword storage memory B 45 (step S403) and notifies the condition to an information providing server 44 which has registered notification for the keyword (step S404). Having received the notification, the information providing server 44 sends an advertisement to the keyword transmitting server 43 (step S404). The server 43 sends the received advertisement to the web server B 42 (step S405). The web server B 42 adds the advertisement to the content and then provides the content to the portable information terminal 10 as a request source (step S406). The terminal 10 then displays the provided content on the display 205.

As described above, in accordance with the embodiment, since the degree of interest of the user can be acquired on the side of the portable information terminal, the processing load on the server side is lowered. Therefore, the number of users which can be processed by one server is increased, and hence the facility cost of the service provider is reduced. Moreover, since the degree of interest of the user is notified at content request, if an advertisement destination matching a content is beforehand registered, the information providing operation such as the providing operation of an advertisement or an address to store the advertisement can be achieved within one access time without increasing the load of the service provider to install facilities. Consequently, an information provider matching requirements of a user as well as a user matching requirements of an information provider can be determined through an enquiry at a high speed and at a low cost.

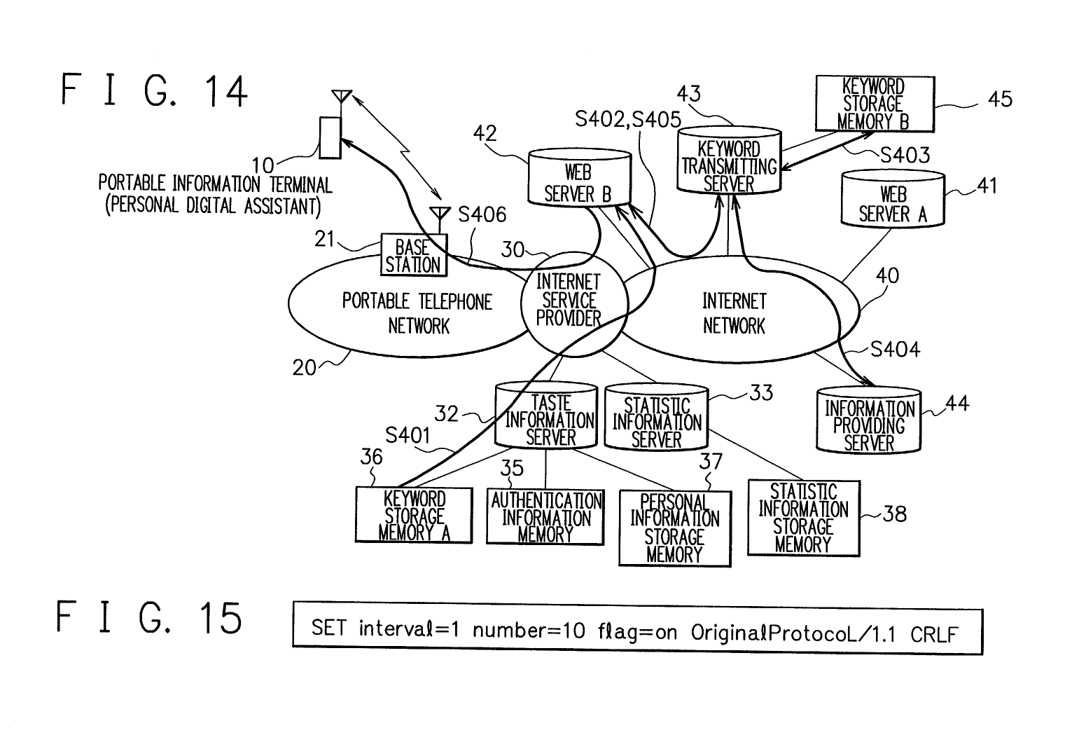

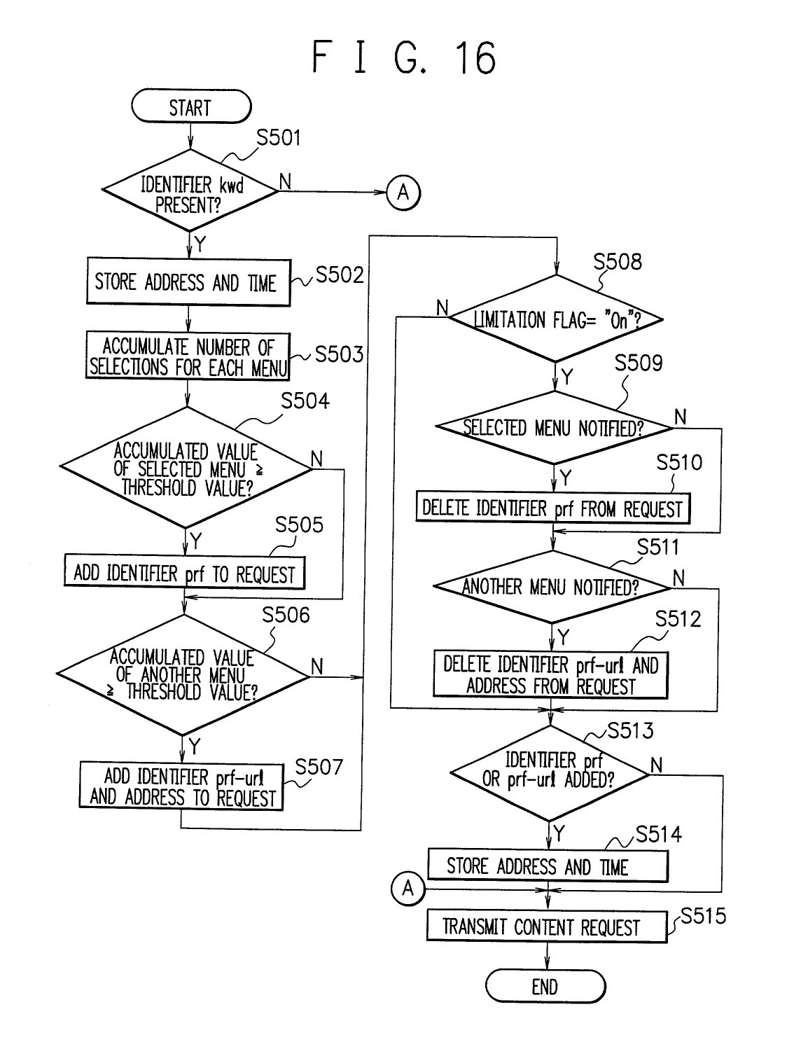

Next, description will be given of a second embodiment in accordance with the present invention. This embodiment differs from the first embodiment in that the information collecting reference value and the information reporting reference value for information indicating the degree of interest of a user can be changed in response to an external request. Description will be given of an example in which the information collecting reference value, the information reporting reference value, and the like for information indicating the degree of interest of a user is changed in response to a request from the Internet service provider 30. FIG. 15 shows an example of a description format of a statistic parameter setting request sent from the Internet service provider 30 to the terminal 10. In this example, the statistic parameter setting request includes an identifier “SET” indicating a statistical parameter setting request as a first element, statistic parameters including a statistic operation interval (number of days), a statistic threshold value (frequency), and a limitation flag (limited by “on”), a type and a version number of the communication protocol, and an end code. The respective elements are separated by a space from each other. Having received the statistic parameter setting request, the terminal 10 stores the parameter in the RAM 203 to use the parameter in response to a menu selection.

The statistic operation interval is used as a parameter to determine whether or not the interesting field information sent from the terminal is matching the actual interest of the user at this point of time. By decreasing the statistic operation interval, the desire of the user set as above reflects his or her desire at a point of time nearer to the current time. The statistic threshold value is a parameter to determine a degree of the interest in the interesting field information. By increasing the statistic threshold value, it is possible to determine a user who is deeply interested in the field. The limitation flag is disposed to limit transmission of unnecessary interesting field information. If it is not required to send the same interesting filed information during one statistic operation interval, the limitation flag is favorably set to on. The statistic parameters are determined according to a contract between the Internet service provider and the information supplier such as an advertiser or an advertisement agent.

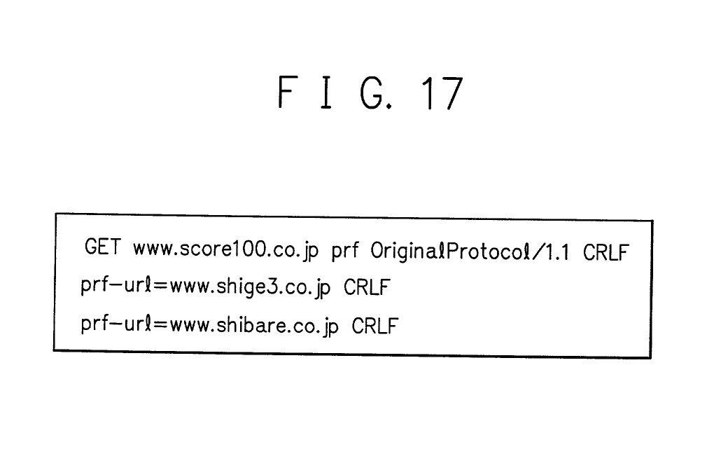

Referring next to FIG. 16, description will be given of operation when a user selects a menu of the terminal 10. FIG. 16 shows a flow of processing in the second embodiment when a user selects a menu of the terminal 10. When the selected menu includes an identifier “kwd” (Y in step S501), the terminal 10 stores an address of a web server corresponding to the selected menu and a time of the selection in the interesting field storage memory (step S502). Within a predetermined period of the statistic operation interval from the current point of time, the terminal 10 accumulates the number of selections for each menu (step S503). If the number of selections of a menu selected immediately before exceeds a predetermined statistic threshold value (Y in step S504), the terminal 10 adds an identifier “prf” after the URL in the content request (step S505). If there exits another menu for which the number of selections exceeds a predetermined statistic threshold value (Y in step S506), the terminal 10 adds an identifier “prf-url” and an address of a web server corresponding to the menu to the content request (step S507). FIG. 17 shows an example of a description format of the content request in this operation.

Subsequently, the terminal 10 checks the limitation flag (step S508). If the flag is on, the terminal 10 refers to the notification information storage memory to determine whether or not a notification that the menu selected within a predetermined statistic interval is an interesting field has been sent to the taste information server 32 (step S509). Only if the notification has been sent to the server 32, the terminal 10 deletes the identifier “prf” (step S510). For each of the other menus, the terminal 10 determines whether or not a notification that the menu selected within a predetermined statistic interval is an interesting field has been sent to the taste information server 32 (step S511). In this situation, only if the notification has been sent to the server 32, the terminal 10 deletes the identifier “prf-url” and the address of the web server (step S512).

Next, the terminal 10 determines whether or not the content request includes an identifier “prf” or “prf-url” (step S513). Only if the request includes the identifier, the terminal 10 stores an address of a web server associated with the identifier “prf” or “prf-url” and a current time in the notification information storage memory (step S514) and then sends the content request (step S515). The notification information storage memory is arranged in the RAM 203. The CPU 201 makes a search through the RAM 203 to determine whether or not the notification is sent to the taste information server 32 according to presence or absence of an address equal to the address of the web server associated with the identifier “prf” or “prf-url” and the time information.

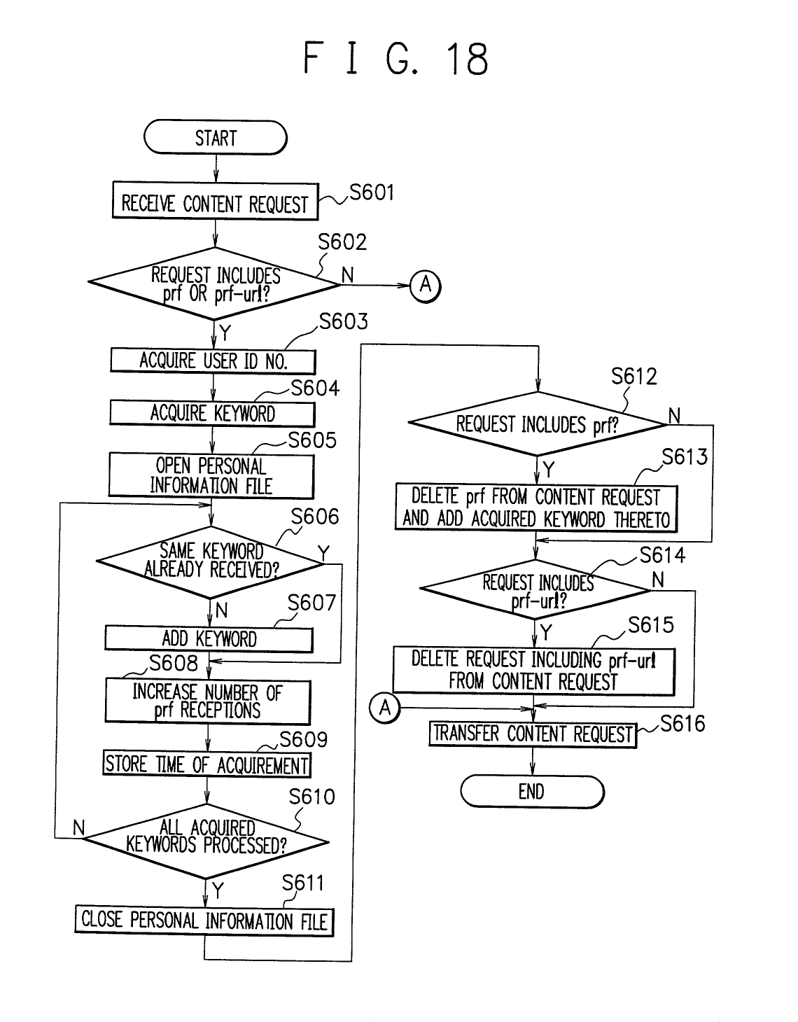

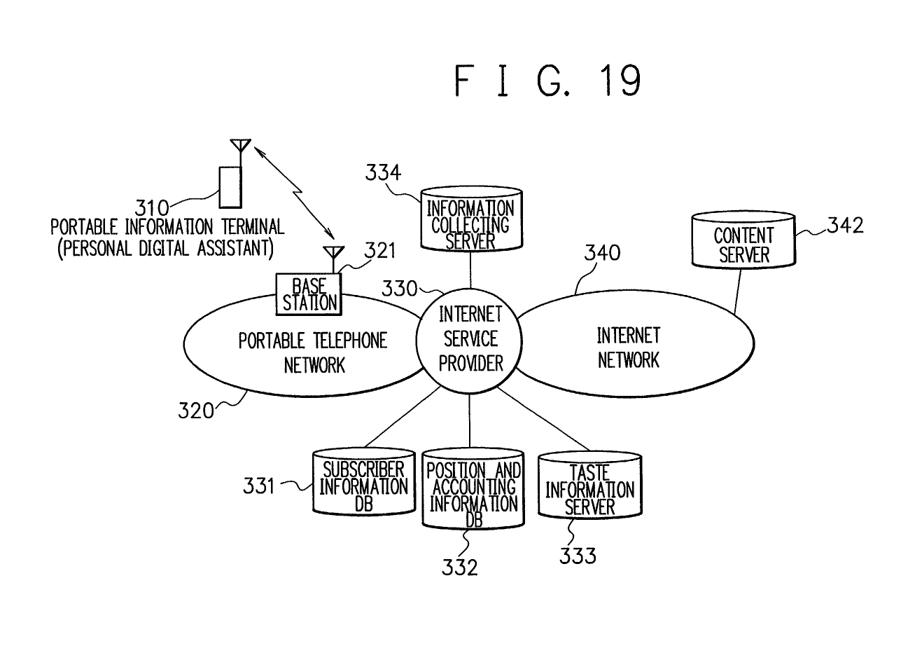

The content request sent from the terminal 10 according to the service menu is received by the Internet service provider 30 and is processed by the taste information server 32. Referring now to FIG. 18, description will be given of operation of the taste information server 32. FIG. 18 shows a flow of processing of the taste information server 32 in the second embodiment when the terminal 10 issues a content request using the service menu. Having received a content request from the terminal 10 (step S601), the server 32 determines whether or not the content request includes an identifier “prf” or “prf-url” (step S602). If the request includes the identifier “prf” or “prf-url”, the server 32 accesses the authentication memory 35 using an access ID in the content request to acquire a user ID number therefrom (step S603). The server 32 then accesses the keyword storage memory A 36 according to an URL (content request destination) in the content request to obtain a keyword therefrom (step S604).

According to the user ID number, the server 32 opens an information file of the user from the personal information storage memory 37 (step S605) and determines whether or not the memory 37 contains a keyword equal to the obtained keyword (step S606). If the memory 37 contains the same keyword as a result, the server 32 incrementally increases the number of receptions of the identifier “prf” associated with the stored keyword (step S608). Otherwise, the keyword is added as a new item to the file (step S607) and then incrementally increases the number of receptions of the identifier “prf” associated with the stored keyword (step S608). In the regard, when a keyword is first added to the file, the initial value of the number of receptions of the identifier “prf” is “0”, and the value is incremented to “1” in step S608.

After incrementing the number of receptions of the identifier “prf”, the server 32 stores a current time of this operation (step S609). Subsequently, the server 32 determined whether or not the obtained keywords have already been completely processed (step S610). Until the processing is completely executed for all keywords, the server 32 repeatedly executes the operation beginning at step S606. When the processing is finished for the keywords, the serve 32 closes the file (step S611). In the operation, it is assumed that a time of the file closing operation is recorded in the file attribute. Next, the server 32 determines whether or not the content request includes an identifier “prf” (step S612). If this is the case, the server 32 deletes the identifier “prf” and adds in place thereof a keyword obtained from the keyword storage memory A 36 using the address of the web server for which the identifier “prf” is added (step S613).

Subsequently, the server 32 determines whether or not the content request includes an identifier “prf-url” (step S614). If the content request includes the identifier “prf-url”, the server 32 deletes a request indicated by the identifier “prf-url” (step S615) and then transfers the content request to a web server as the content request destination (step S616). If the request does not include the identifier “prf” or “prf-url” in step S602, the server 32 transfers the content request directly to the web server as the content request destination (step S616). Incidentally, operation after the reception of the content request by the web server is the same as that of the first embodiment and hence will not be described.

In accordance with this embodiment, the degree of interest of the user is obtained on the side of the portable information terminal and the information collecting reference value and the information reporting reference value for information indicating the degree of interest of a user can be changed by an external request. Consequently, the processing load is reduced on the server side and various statistic processing results can be obtained for the taste information of the user. Resultantly, an information provider satisfying requirements of a user as well as a user satisfying requirements of an information provider can be determined through an enquiry at a high speed and at a low cost.

In the description of the embodiment, the terminal device is a portable computer including a wireless communication function or a portable information terminal (a personal digital assistant) such as a portable telephone. However, the terminal device in accordance with the present invention is not restricted by the embodiment. That is, for example, a fixed terminal device such as a personal computer coupled with a fixed telephone terminal can be naturally employed.

As described above, in accordance with the present invention, the terminal device includes a content requesting unit for issuing a content request to request a content selected by a user according to a content menu disposed for the user to select a desired content, a counting unit for counting a number of requests of a content requested by the content requesting unit, and a notifying unit for notifying information of a content of which the number of requests satisfies a predetermined notification condition, the information being added to the content request. Therefore, it is possible to notify that the content belongs to a field matching the taste of the user. Resultantly, the load to collect taste information is reduced on the server side, and hence the number of servers to cope with concentrated accesses can be decreased. This leads to an advantage that the load to install facilities on the service provider side is decreased. Moreover, since the processing condition of the information to be collected can be changed by the unit to receive and to store the notification condition, a user matching requirements of an information provider can be determined through an enquiry at a high speed and at a low cost.

The information collecting method in accordance with the present invention includes the a terminal device described above; an Internet connection service providing unit including a counting unit for receiving a content request sent from the terminal device and counting a number of notifications of information of a content added to the content request, a storage unit for storing the number of notifications and user information of the user with a correspondence established therebetween, and a transfer unit for removing data added to the content request and for transferring the content request to a content server as a request destination; and a communication network for mutually connecting a plurality of terminal devices and the Internet connection service providing unit to each other. Therefore, the Internet connection service providing unit can collect the taste information of a user who browses contents provided by a content server connected to the Internet network. Consequently, it is not required for the Internet connection service providing unit to obtain a tendency of taste each time a user browses the content server, and hence the processing load thereof is reduced. Therefore, the number of servers to process concentrated accesses can be decreased, which advantageously lowers the load to install facilities.

Moreover, the information collecting method in accordance with the present invention includes the steps of counting, by a terminal device, a number of requests for each content to which the terminal device issued a request; adding, to a content request, information of the content of which the number of requests satisfies a predetermined notification condition and thereby notifying the information of the content; and receiving, by an Internet connection service providing unit, a content request sent from the terminal device, counting a number of notifications of information of a content added to the content request, storing the number of notifications and user information of the user with a correspondence established therebetween, and removing data added to the content request and transferring the content request to a content server as a request destination. Therefore, the Internet connection service providing unit can collect the taste information, obtained by the terminal device, of a user browsing contents provided by a content server linked with the Internet network. According to this method, it is not necessary for the Internet connection service providing unit to acquire a tendency of taste each time a user browses the content server. This reduces the processing load of the Internet connection service providing unit. Therefore, the number of servers to process concentrated accesses can be decreased, and the load to install facilities is advantageously lowered.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A terminal device coupled via a communication line to Internet connection service providing means for browsing via an Internet network a content server having stored contents therein, comprising:
content requesting means for issuing a content request to request a content selected by a user according to a content menu disposed for the user to select a desired content;
counting means for counting a number of requests of a content requested by said content requesting means; and
notifying means for notifying information of a content of which the number of requests satisfies a predetermined notification condition, the information being added to the content request.

2. A terminal device coupled via a communication line to Internet connection service providing means for browsing via an Internet network a content server having stored contents therein, comprising:
content requesting means for issuing a content request to request a content selected by a user according to a content menu disposed for the user to select a desired content;
counting means for counting a number of requests of a content requested by said content requesting means; and
notifying means for notifying information of a content of which the number of requests satisfies a predetermined notification condition, the information being added to the content request
the counting means comprises:
storage means for storing therein the number of requests for each address of a content server in which the content selected by the user is stored; and
adding means for adding the number of requests of the content for each request for the content,
or
the counting means comprises:
storage means for storing therein an address of said content server in which the content selected by the user is stored and a day and time of the selection; and
totaling means for conducting a retrieval through said storage means and for totaling the number of requests for each content within a predetermined period of time.

3. A terminal device coupled via a communication line to Internet connection service providing means for browsing via an Internet network a content server having stored contents therein, comprising:
content requesting means for issuing a content request to request a content selected by a user according to a content menu disposed for the user to select a desired content;
counting means for counting a number of requests of a content requested by said content requesting means;
notifying means for notifying information of a content of which the number of requests satisfies a predetermined notification condition, the information being added to the content request; and
further comprising wireless communication means to be coupled with said communication line via wireless communication.

4. A terminal device coupled via a communication line to Internet connection service providing means for browsing via an Internet network a content server having stored contents therein, comprising:
content requesting means for issuing a content request to request a content selected by a user according to a content menu disposed for the user to select a desired content;
counting means for counting a number of requests of a content requested by said content requesting means; and
notifying means for notifying information of a content of which the number of requests satisfies a predetermined notification condition, the information being added to the content request
the counting means comprises:
storage means for storing therein the number of requests for each address of a content server in which the content selected by the user is stored; and
adding means for adding the number of requests of the content for each request for the content,
or
the counting means comprises:
storage means for storing therein an address of said content server in which the content selected by the user is stored and a day and time of the selection; and
totaling means for conducting, a retrieval through said storage means and for totaling the number of requests for each content within a predetermined period of time; and
further comprising wireless communication means to be coupled with said communication line via wireless communication.

5. A terminal device in accordance with claims 1, wherein said content requesting means comprises means for receiving and storing the content menu therein.

6. The terminal device in accordance with claim 2, wherein said content requesting means comprises means for receiving and storing the content menu therein.

7. The terminal device in accordance with claim 3, wherein said content requesting means comprises means for receiving and storing the content menu therein.

8. The terminal device in accordance with claim 4, wherein said content requesting means comprises means for receiving and storing the content menu therein.

9. The terminal device in accordance with one of claim 1, wherein said notifying means comprises means for receiving and storing the notification condition therein.

10. The terminal device in accordance with one of claim 2, wherein said notifying means comprises means for receiving and storing the notification condition therein.

11. The terminal device in accordance with one of claim 3, wherein said notifying means comprises means for receiving and storing the notification condition therein.

12. The terminal device in accordance with one of claim 4, wherein said notifying means comprises means for receiving and storing the notification condition therein.

13. A terminal device in accordance with one of claim 5, wherein said notifying means comprises means for receiving and storing the notification condition therein.

14. The terminal device in accordance with one of claim 6, wherein said notifying means comprises means for receiving and storing the notification condition therein.

15. A terminal device in accordance with one of claim 7, wherein said notifying means comprises means for receiving and storing the notification condition therein.

16. A terminal device in accordance with one of claim 8, wherein said notifying means comprises means for receiving and storing the notification condition therein.

17. An information collecting system for collecting taste information of taste of a user who browses a content provided by a content server connected to an Internet network, comprising:
a terminal device in accordance with one of claims 1 to 16;
Internet connection service providing means comprising
counting means for receiving a content requestsent from the terminal device and counting a number of notifications of information of a content added to the content request,
storage means for storing the number of notifications and user information of the user with a correspondence established therebetween, and
transfer means for removing data added to the content request and for transferring the content request to a content server as a request destination; and
a communication network for mutually connecting a plural units of said terminal devices and said Internet connection service providing means to each other.

18. An information collecting system in accordance with claim 17, further comprising:
a terminal device in accordance with claim 5 in place of a terminal device in accordance with one of claims 1 to 4; and
content menu providing means connected via an Internet network to said Internet connection service providing means for the user to select a desired content.

19. An information collecting system in accordance with claim 17, further comprising:
a terminal device in accordance with claim 6 in place of a terminal device in accordance with one of claims 1 to 4; and
notification condition transmitting means for transmitting the notification condition to said terminal device.

20. An information collecting method of collecting taste information of taste of a user who browses a content provided by a content server connected to an Internet network, comprising the steps of:
counting, by a terminal device, a number of requests for each content to which the terminal device issued a request; adding, to a content request, information of the content of which the number of requests satisfies a predetermined notification condition and thereby notifying the information of the content; and
receiving, by an Internet connection service providing means, a content request sent from the terminal device, counting a number of notifications of information of a content added to the content request, storing the number of notifications and user information of the user with a correspondence established therebetween, and removing data added to the content request and transferring the content request to a content server as a request destination.

21. An information collecting method in accordance with claim 20, further comprising the steps of:
transmitting, by content menu providing means including a content menu for the user to select a desired content, the content menu via the Internet connection service providing means to the terminal device; and
receiving the content menu by the terminal device for use of selection of a content and request for a content.

22. An information collecting method in accordance with claim 20, further comprising the steps of:
transmitting the notification condition by Internet connection service providing means; and
receiving, by the terminal device,
the notification condition, adding information of the content to a content request, and notifying the content request.

23. An information collecting method in accordance with claim 21, further comprising the steps of:
transmitting the notification condition by Internet connection service providing means; and
receiving, by the terminal device,
the notification condition, adding information of the content to a content request, and notifying the content request.
